(19) United States
(12) Patent Application Publication
(10) Pub. No.: US 2006/0127834 A1
(43) Pub. Date: Jun. 15, 2006

(54) Orthodontic kits and methods

(75) Inventors: Waldemar B. Szwajkowski, La Canada, CA (US); Arthur J. Basehart, Yorba Linda, CA (US); James D. Cleary, Glendora, CA (US); Oliver L. Puttler, La Crescenta, CA (US); David K. Cinader, Jr., Yorba Linda, CA (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/009,242

(22) Filed: Dec. 9, 2004

(51) Int. Cl. A61C 3/00

(52) U.S. Cl. 433/2; 206/63.5; 433/24

(57) ABSTRACT

An orthodontic kit includes brackets and at least one archwire for a single patient. The brackets and archwire are provided in a sealed container that is sterilized after the container is closed. Optionally, the kit includes all or at least some of the additional orthodontic articles desired for a bonding procedure, such as buccal tubes or buccal tube preweld assemblies, ligatures, bonding compositions, single use hand instruments and articles for moisture control.

### BACKGROUND OF THE INVENTION

1. Field of the Invention

This invention broadly relates to kits containing articles for use by an orthodontic practitioner.

2. Description of the Related Art

Orthodontic treatment is a specialized field within the practice of dentistry, and involves movement of malpositioned teeth to improved orientations in the oral cavity. Orthodontic treatment can greatly enhance the aesthetic appearance of the patient's oral cavity, especially in regions near the front of the patient's mouth. Orthodontic treatment can also improve the function of the teeth so that the opposing teeth work better with each other during mastication.

One type of common orthodontic treatment includes the use of a set of tiny, slotted appliances known as brackets that are affixed to the patient's teeth. An archwire is received in the slots of the brackets and forms a track to guide movement of the teeth to desired positions. Ends of the archwires are often received in buccal tube appliances that are affixed to the patient's molar teeth. The brackets, archwires and buccal tubes are commonly known collectively as “braces”.

At the beginning of orthodontic treatment, the practitioner typically reviews the patient's teeth and malocclusion and selects the brackets, buccal tubes and archwires for use in moving the patient's teeth to desired positions. A wide variety of brackets are available, including brackets made of metallic materials, brackets made of ceramic materials and brackets made of polymeric materials. In addition, a number of brackets and buccal tubes with differing shapes and functions are available for each tooth of the patient's dental arch. This range of choice enables the practitioner to select particular brackets and buccal tubes in accordance with the practitioner's preferred treatment technique and in view of the particular malocclusion at hand.

In addition, a variety of orthodontic archwires are available in various sizes, shapes and materials. For example, archwires are commonly available in stainless steel, in alloys of nickel-titanium and alloys of beta-titanium. The archwires may have a solid cross-sectional configuration or a construction that is made by twisting or braiding numerous small-diameter wires together. Orthodontic archwires are also available in varying degrees of stiffness and different cross-sectional shapes and dimensions. Moreover, archwires are available in a wide variety of overall shapes such as tapered, square and ovoid, and such archwires may be available in various colors such as gold, tooth-colored or metallic.

Many practitioners retain an inventory of brackets, archwires and buccal tubes on hand. However, such an inventory may represent a significant expense, especially if a wide variety of appliances are retained. Proper maintenance of the inventory may require a significant amount of time on a periodic basis to ensure that the existing inventory is sufficient and that reorders are placed in accordance with the expected rates of usage in the future.

Moreover, some of the articles used in the course of orthodontic treatment may have a limited shelf life time that should not be exceeded for best results. For example, many orthodontic adhesives should be retained in inventory for only a limited amount of time and should be used before the expiration date provided on the package in order to help ensure that the characteristics of the adhesive are not adversely affected to an undue extent. As can be appreciated, the practice of maintaining an inventory of orthodontic articles in the practitioner's office should take into account shelf life considerations as needed.

### SUMMARY OF THE INVENTION

The present invention is directed to methods of providing orthodontic articles, including brackets and archwires to an orthodontic practitioner, in a single container or kit adapted for use with a single patient. Optionally, the container can include other orthodontic articles for the patient that will also be needed during the time that the brackets and archwires are installed.

Optionally, the single patient kit of the present invention can be customized for a particular patient by the manufacturer. For example, after diagnosing the patient's malocclusion, the practitioner may request the manufacturer to include certain brackets, archwires or other orthodontic articles in the kit that are deemed to best treat the patient at hand. As a result, the amount of articles kept in inventory in the practitioner's office can be significantly reduced.

Advantageously, the entire kit including all of the articles in the container is sterilized after the container is closed. Preferably, the entire kit is sterilized by the manufacturer before shipment to the practitioner. As a result, less preparation and set-up time in the practitioner's office is needed prior to the installation of the braces in the patient's oral cavity. In addition, the likelihood of transferring an infectious disease to the patient is significantly reduced.

In more detail, the present invention relates in one aspect toward a method of providing orthodontic articles to an orthodontic practitioner. The method comprises:

selecting a set of brackets for a single patient;

selecting at least one archwire for the patient;

placing the set of brackets and the archwire in a container;

sterilizing the container while the brackets and the archwire are in the container; and

transporting the container with the bracket and the archwire to an orthodontic practitioner.

The present invention also relates in another aspect toward a method of providing orthodontic articles to an orthodontic practitioner. This method comprises:

selecting a set of brackets for a single patient;

selecting at least one archwire for the patient;

placing the set of brackets and the archwire on a substrate;

transporting the substrate with the brackets and the archwire to an orthodontic practitioner; and

placing the substrate with the brackets and the archwire at a location adjacent an orthodontic patient's chair.

Other aspects of the present invention relate to orthodontic kits that are constructed using the method described above.

These and other aspects of the invention will be described in more detail in the paragraphs that follow and are illustrated in the accompanying drawings.

### BRIEF DESCRIPTION OF THE DRAWINGS

FIG. 1 is a top view of an orthodontic kit that is constructed according to one embodiment of the present invention;

FIG. 2 is a side cross-sectional view of the kit depicted in FIG. 1, taken along lines 2-2 of FIG. 1, except that a cover of the kit has been opened;

FIG. 3 is a top view of an orthodontic kit according to another embodiment of the invention;

FIG. 4 is a side cross-sectional view taken along lines 4-4 of FIG. 3;

FIG. 5 is a top view of an orthodontic kit that is constructed in accordance with yet another embodiment of the invention;

FIG. 6 is an enlarged perspective view of an indirect bond assembly of the kit depicted in FIG. 5, except that the indirect bond assembly is shown with its cover in an opened position; and

FIG. 7 is a reduced perspective view of a plurality of kits including the kit shown in FIG. 1, wherein the kits are received in a storage unit.

### DETAILED DESCRIPTION OF THE PREFERRED EMBODIMENTS

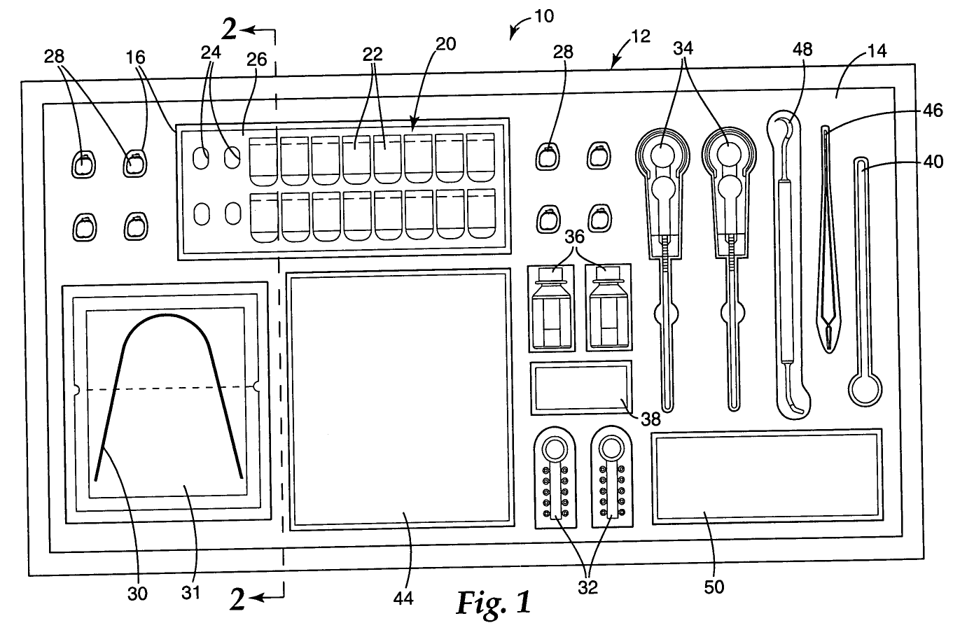

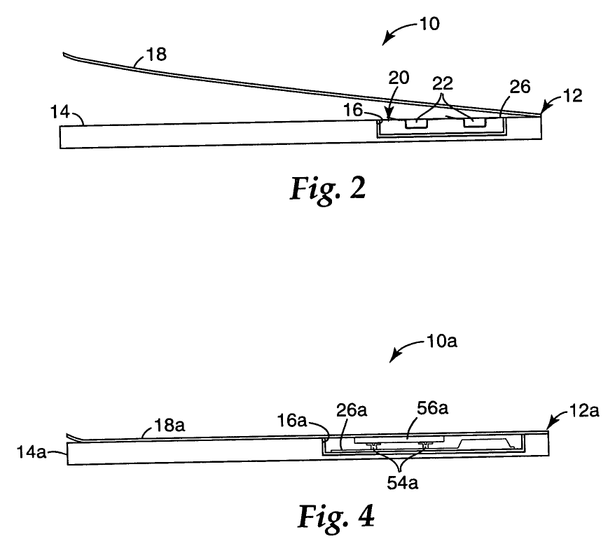

An orthodontic kit according to one embodiment of the invention is illustrated in FIGS. 1 and 2 and is broadly designated by the numeral 10. The kit 10 includes a container 12 that comprises a substrate 14 having at least one and preferably a plurality of wells or recesses 16. A number of orthodontic articles are received in the recesses 16 as will be described in the paragraphs that follow.

The container 12 also includes a cover 18 that is shown only in FIG. 2. In this embodiment, the cover 18 is constructed of a sheet of flexible material such as polymeric material, and is detachably connected to a peripheral shoulder or rim of the substrate 14 by an adhesive. To open the container 12, the cover 18 is lifted from the shoulder and peeled away from the substrate 14 as illustrated in FIG. 2.

A variety of other constructions are also possible. For example, the cover 18 could be connected to the substrate 14 by a hermetic seal or heat seal. As another option, the cover 18 may be made of a rigid or semi-rigid material such as a sheet of polycarbonate. Optionally, the cover 18 transmits sufficient light in the range of visible wavelengths so that the contents of the container 12 including all of the orthodontic articles therein can be readily observed without lifting the cover 18 from the substrate 14.

Suitable materials for the container 12, including the substrate 14 and the cover 18, include polymeric materials such as polypropylene, polyethylene and polyethylene terephthalate (“PETG”). If the kit 10 includes orthodontic adhesives or other compositions that are curable upon exposure to actinic radiation, such as light in the visible wavelength region, the container 12 including the substrate 14 and the cover 18 may be made of a material that blocks or at least hinders the passage of actinic radiation.

The kit 10 includes a number of orthodontic articles for a single patient undergoing orthodontic therapy. In this embodiment, the kit 10 includes an assembly 20 of adhesive precoated brackets such as “APC” brand brackets from 3M Unitek. Each bracket of the assembly 20 is received in a separate blister container or enclosure 22. In turn, each of the enclosures 22 is releasably received in a corresponding opening 24 of a set-up tray 26.

The set-up tray 26 is releasably received in one of the recesses 16. Preferably, this recess has a shape that is similar to the overall shape of the set-up tray 26. Optionally, the set-up tray 26 is detachably connected to the substrate 14 of the container 12 by an adhesive, by clips or other structure.

Examples of suitable enclosures 22 are described in U.S. Pat. Nos. 5,350,059, 5,538,129, 6,089,861 and U.S. Patent Application Publication No. 2003/0196914. Examples of suitable set-up trays 26 are described in U.S. Pat. No. 5,350,059 and pending U.S. patent application Ser. No. 10/804,861, filed Mar. 19, 2004.

In the illustrated embodiment, the set-up tray 26 includes ten openings 24 to receive ten enclosures 22 containing brackets for ten teeth of the patient's upper jaw, and ten openings 24 to receive ten enclosures 22 containing brackets for ten teeth of the patient's lower jaw. As an alternative, however, the set-up tray 26 may have a greater or smaller number of openings 24 in instances where a greater or smaller number of enclosures with brackets are desired. For purposes of illustration, four enclosures 22 have been omitted in FIG. 1 in order to show the openings 24.

The kit 10 also includes eight “preweld” assemblies 28, one for each of the first and second molar teeth of the patient's upper and lower dental arches. Each of the assemblies 28 comprises an orthodontic band having a size and shape adapted to encircle the patient's tooth, as well as a buccal tube that is connected to the band by, for example, a brazed or welded joint. Examples of suitable preweld assemblies are described in U.S. Pat. No. 5,753,884 and published U.S. Patent Application 2004/0101799. As shown in FIG. 1, the preweld assemblies 28 are preferably positioned next to the ends of the set-up tray 26 in locations corresponding to their respective placements in the dental arches and next to the enclosures 22 that contain the brackets for the adjacent teeth.

In this embodiment, the preweld assemblies 28 are each received in a respective recess 16 of the substrate 14, and these recesses 16 have a shape similar to the preweld assemblies 28 in order to reduce lateral movement of the assemblies 28 relative to the substrate 14 when the cover 18 is closed. However, other constructions are possible. For example, the preweld assemblies 28 may be received in individual pouch-like envelopes or bags that are placed in one or more recesses, and the envelopes may bear labels to indicate their intended tooth location in the oral cavity.

The kit 10 preferably includes at least one archwire 30 for connection to the brackets of the assembly 20 and buccal tubes of the preweld assemblies 28. If the assembly 20 includes brackets for both the patient's upper and lower dental arches, the kit 10 preferably includes two archwires, one for the upper dental arch and one for the lower dental arch. Each archwire 30 is preferably received in a corresponding package 31. Examples of suitable packages 31 are described in U.S. Pat. No. 5,836,444. Alternatively, the archwire(s) 30 may be received in “U”-shaped recesses formed in the substrate 14 without accompanying packages.

Examples of suitable archwires include Unitek brand nitinol heat-activated archwires, Unitek brand nitinol super elastic archwires, Unitek brand nickel titanium super-elastic archwires, Unitek brand nitinol classic archwires and Unitek brand beta III titanium archwires, all from 3M Unitek Corporation. The archwires may have a rectangular, square or circular cross-sectional configuration, and may be comprised of a single strand or multiple strands that are braided or twisted together. The archwires 30 may have a tapered, square or ovoid configuration, and may be provided with a reverse curve of Spee.

Preferably, the kit 10 also includes other orthodontic articles to be used in the practitioner's office during the procedure of affixing the brackets and pre-weld assemblies 28 to the patient's teeth and installing the archwires 30 in the brackets and buccal tubes. In the embodiment shown in FIGS. 1 and 2, the kit 10 includes a ligature dispenser 32 that comprises a central runner or carrier and a number of O-ring ligatures that are arranged in a row along each side of the carrier. The ligatures are integrally connected to the carrier by a relatively weak section that can be ruptured when it is desired to detach the ligatures from the carrier for use.

The ligatures of the dispenser 32 are used to retain the archwire in the slots of the brackets after the brackets have been mounted on the patient's teeth. Examples of suitable ligature dispensers 32 are described in U.S. Pat. Nos. 4,038,753, 5,984,674 and 6,280,186. Suitable commercially available ligature dispensers include “AlastiK” brand Easy-To-Tie ligature dispensers, “Mini-StiK” brand ligature dispensers, and “QuiK-StiK” brand ligature dispensers, all from 3M Unitek.

In addition, the kit 10 preferably includes some and more preferably includes all of the compositions useful in the procedure for mounting the brackets and the preweld assemblies 28 on the patient's teeth. In this embodiment, the kit 10 includes two foil packs 34 containing a self-etching primer that is applied by an accompanying disposable applicator. The self-etching primer is applied to the surface of the teeth prior to the placement of the adhesive precoated brackets. An example of a suitable self-etching primer is “Transbond” Plus brand Self-Etching Primer from 3M Unitek. Examples of suitable packs 34 are described in U.S. Pat. No. 6,105,761.

The kit 10 also includes a composition useful for mounting the preweld assemblies 28 on the patient's molar teeth. In this embodiment, the kit 10 includes a glass ionomer band cement that is provided as two initially separate components that are contained in respective bottles 36. One of the bottles 36 contains the powder of the cement and the other bottle 36 includes the liquid of the cement. After the bottles 36 are opened and the powder and liquid are mixed together, the resulting composition is applied to the inside of the band before the band is mounted on the patient's tooth. An example of a suitable glass ionomer band cement is “Unitek” brand multi-cure glass ionomer band cement from 3M Unitek.

The kit 10 further includes a mixing pad 38 for receiving and mixing the powder and liquid initially contained in the bottles 36. Preferably, the mixing pad 38 is detachably connected to the substrate 14 so that the mixing pad 38 can be removed from the container 12 and placed in a convenient location according to the practitioner's preferences, such as a countertop or a tray that is adjacent the patient's chair.

The kit 10 further includes disposable items for mixing the band cement and applying the mixed cement to the band of the preweld assemblies 28. As illustrated in FIG. 1, the kit 10 includes a disposable measuring and dispensing spoon 40 for measuring and dispensing a quantity of powder from the bottle 36. The kit 10 also includes a disposable spatula or brush (not shown) for mixing the powder and liquid together on the pad 38 and for applying the resultant mixed composition to the inner surface of the bands of the preweld assemblies 28. Preferably, both the mixing spoon 40 and the brush are received in respective recesses 16.

Optionally, the kit 10 includes a packet 44 that is matingly received in one of the recesses 16. The packet 44 includes articles for controlling moisture during the procedure of securing the brackets and preweld assemblies to the patient's teeth. Examples of suitable articles in the packet 44 include a labial saliva ejector and tongue holder assembly, such as no. 709-020 from 3M Unitek. Other examples of suitable articles in the packet 44 include other items useful in the bonding procedure, such as cotton rolls, bite blocks and disposable cheek retractors.

In this embodiment, the kit 10 also includes a disposable bracket holder 46 for placing the orthodontic brackets on the patient's teeth. The bracket holder 46 is a reverse-action, tweezers-style placement instrument that is made from a high strength plastic material. Other types of placement instruments are also possible.

The kit 10 also contains a disposable scaler or adhesive remover 48 having tips for removing excess adhesive or cement from the patient's tooth enamel after the brackets and preweld assemblies have been mounted on the patient's teeth. Examples of an adhesive remover include nos. 900-821 and 900-822 from 3M Unitek. Preferably, however, the adhesive remover 48 is made of a high strength plastic material, and both the adhesive remover 48 and the bracket holder 46 are received in respective recesses 16.

The kit 10 may also optionally include other hand instruments as well. Examples of such other hand instruments include ligature directors, molar band seaters and/or pushers, forceps, mouth mirrors, bracket positioning gauges and the like.

In instances where the patient has a Class II or Class III malocclusion, the kit 10 preferably includes appliances for suitable correction of that malocclusion. In the embodiment shown in FIGS. 1 and 2, the kit 10 includes a package 50 containing telescoping spring Class II corrector (not shown) such as Forsus brand Fatigue Resistant Device from 3M Unitek. The package 50 containing the Class II corrector also preferably includes other components such as couplings that may be needed for attachment of the corrector to other appliances in the patient's oral cavity.

Preferably, all of the articles of the kit 10 are placed in the container 12 and the cover 18 is then sealed to the substrate 14 by the manufacturer. Optionally, a number of kits 10 can be manufactured in advance, using brackets, archwires and other articles adapted for use with a pre-defined range of dental arch configurations. Alternatively, the kit 10 is a custom kit that is assembled by the manufacturer for a particular patient. For example, the practitioner may select brackets, archwires and other articles for the particular shape of the dental arches and for the particular type of malocclusion at hand.

For example, the practitioner may order the kit 10 from a website provided by the manufacturer after initial diagnosis of the patient's malocclusion. The brackets and archwires may be selected according to the practitioner's preferred treatment techniques using an interactive program that enables the practitioner to select brackets from a list of available brackets. Preferably, the list of brackets includes brackets that are manufactured in advance and kept in the manufacturer's inventory. Preferably, the list of brackets first identified to the practitioner in the interactive program presents a list of the practitioner's favored brackets by prescription type, composition, brand name and/or other identifiers, and/or a list of the practitioner's most recently selected brackets by prescription, composition, brand name and/or other identifiers. The practitioner also selects the archwires 30 based on the practitioner's diagnosis from a list of available archwires identified on the website. Preferably, the list of available archwires identified to the practitioner in the interactive program includes archwires that are identified as favored by the practitioner and/or recently ordered by the practitioner.

Likewise, many of the remaining articles in the kit 10 may be selected by the practitioner using the interactive program. Optionally, the program provides a default list of certain articles such as ligature dispensers 32, glass ionomer cement such as bottles 36, disposable hand instruments such as the bracket holder 46 and the adhesive remover 48, moisture control articles such as the articles contained in the moisture control packet 44, as well as other articles that are needed during the bonding procedure for a substantial majority of the practitioner's patients. The practitioner can then modify the default list as desired.

The practitioner may select the preweld assemblies 28 using the interactive program by first manually determining the size and shape of the particular tooth and by then selecting the best band for that tooth. Next the practitioner selects a buccal tube for attachment to the band, as well as the location and orientation of the buccal tube on the band. Selection of the proper band may be carried out by trial-fitting a number of different bands on the patient's tooth. Alternatively, a digital data file representing shape of the patient's tooth may be obtained, and then used in a program at the practitioner's office or at the manufacturer's facility in order to pick out the band that is most likely to fit the patient from a number of pre-defined band sizes. Methods for selecting an orthodontic band using digital data are described in U.S. Patent Publication No. 2003-0163291.

Once all of the articles of the kit 10 have been placed in a container 12, the cover 18 is closed. Preferably, the adhesive that connects the cover 18 to the substrate 14 provides a seal that blocks the passage of dust, moisture and/or other contaminates from the environment to areas within the container 12 until such time as the container is opened. Preferably, the container 12 bears an external label that displays identifying information such as the practitioner's name, order number, identity of articles in the kit 10, patient's name, order date, ship date, date of manufacture, lot number(s), brand name(s), manufacturer's name or any combination of the foregoing.

Advantageously, some or all of the information pertaining to the kit 10 (such as the identity of articles in the kit 10, the patient's name, order date, etc.) can be retained on a database by the manufacturer, by the practitioner or by both the manufacturer and the practitioner. In this manner, the information may be retrieved at a later date if necessary. The practitioner may elect to keep such information in a database containing other information relating to that patient, such as a digital data file representing the patient's teeth, diagnostic information, billing information and the like.

Once the kit 10 has been assembled, the container 12 is closed and the cover 18 is sealed to the substrate 14, the entire closed container 12 (including the brackets, buccal tubes, archwires and all other articles in the container 12) is subject to sterilization. Examples of suitable sterilization processes include processes involving gamma irradiation, ethylene oxide, electron beam and hydrogen peroxide gas plasma. Preferably, the kit 10 is sterilized by the manufacturer before shipment of the kit 10 to the practitioner. The seal between the cover 18 and the substrate helps ensure that all of the articles in the kit 10 remain in sterile condition until such time as the kit 10 is opened in the practitioner's office. Optionally, the kit 10 includes an indicator that provides assurance to the practitioner that the kit 10 has been properly sterilized.

A number of variations to the kit 10 are possible. For example, certain of the articles illustrated in FIG. 1 may be omitted from the kit 10, and other articles may be added to the kit 10. Additionally, the kit 10 may include preweld assemblies similar to the assemblies 28 for the patient's bicuspid teeth and/or may include extra-oral appliances such as facebows and headgear. Furthermore, other types of brackets, buccal tubes, appliances, archwires, ligatures, adhesive and hand instruments may be used in place of the articles described above.

Optionally, the container 12 may be placed within another container such as a bag or pouch. Suitable materials for making the pouch containers include foil laminates and polymeric materials such as TYVEK brand polyethylene material from duPont. In embodiments of the invention that include an inner container and an outer container, the inner container 12 need not include a cover that is sealed to the substrate. Instead, the outer container (such as a pouch) is sealed once the inner container has been received within, and the entire kit is then subject to sterilization.

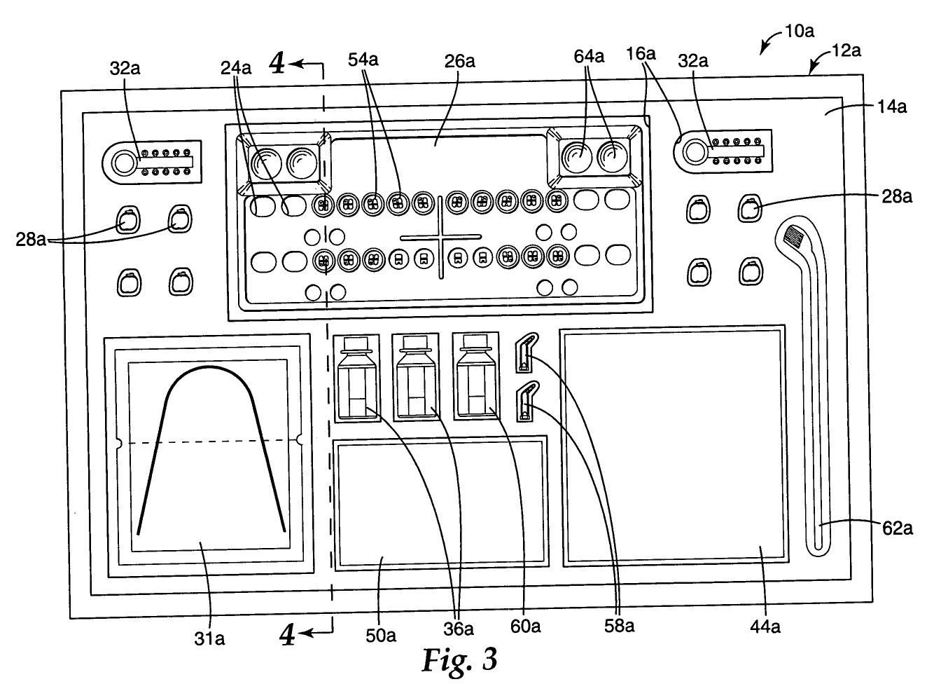

An orthodontic kit 10a according to another embodiment of the invention is illustrated in FIGS. 3 and 4. The kit 10a includes a container 12a that comprises a substrate 14a with a number of recesses 16a. A cover 18a (FIG. 4) is detachably connected to the substrate 14a by an adhesive.

The kit 10a includes a set-up tray 26a that comprises a plastic body with a series of openings 24a. The tray 26a also includes a bottom sheet of material (not shown), and a layer of pressure sensitive adhesive extends across the top of the sheet of material. The pressure sensitive adhesive is exposed in areas defined by the openings 24a. An example of a suitable set-up tray 26a is catalog no. 709-019 from 3M Unitek.

A number of orthodontic brackets 54a are releasably received on the adhesive layer of the set-up tray 26a. In the embodiment illustrated in FIGS. 3 and 4, ten brackets 54a are provided for the central, lateral, cuspid and bicuspid teeth of the patient's upper dental arch, and ten brackets 54a are provided for the central, lateral, cuspid and bicuspid teeth of the patient's lower dental arch. As with the set-up tray 26, the openings 24a of the set-up tray 26a are arranged in a pattern corresponding to the locations of teeth in the upper and lower dental arches. The bracket 54a that is placed in any particular opening is intended for attachment to the corresponding tooth.

As illustrated in the cross-sectional view of the kit 10a depicted in FIG. 4, the cover 18a includes a section 56a of resilient material such as closed cell polymeric foam that extends over the set-up tray 26a. When the cover 18a is closed as shown in FIG. 4, the section 56a of resilient material engages the brackets 54a and urges the same in a direction toward the set-up tray 26a. As a result, the brackets 54a remain in place on the set-up tray 26a until such time as the cover 18a is opened. Alternatively, the set-up tray 26a could include a lidding or be enclosed by a sheet of plastic material to keep the brackets 54a in place until needed.

In this embodiment of the invention, the brackets 54a are not precoated with a layer of orthodontic adhesive by the manufacturer. Instead, the kit 10a is provided with an orthodontic adhesive that is applied to the brackets 54a by the practitioner during the bonding procedure. In this example, the kit 10a includes two capsules 58a for use with an applicator such as adhesive dispensing gun no. 712-032 from 3M Unitek and the applicators described in U.S. Pat. Nos. 5,651,397 and 5,722,829.

As one example, the capsules 58a may contain an orthodontic adhesive that is curable upon exposure to light. Suitable examples of adhesive in the capsules 58a include Transbond XT brand adhesive from 3M Unitek. However, other adhesives are also possible.

The kit 10a also includes a bottle 60a that contains an adhesive primer. An example of a suitable primer is Transbond MIP brand moisture insensitive primer from 3M Unitek. As another option, the kit 10a may include a self-etching primer such as the packs 34 described above in connection with the kit 10.

The kit 10a includes a brush 62a that is received in one of the recesses 16a of the substrate 14a. The brush 62a is useful for applying the primer in the bottle 60a to the patient's tooth surfaces. Advantageously, the set-up tray 26a is provided with four mixing and dispensing wells 64a to receive the primer. In use, the practitioner dispenses a small quantity of primer from the bottle 60a into one of the dispensing wells 64a, and then uses the brush 62a to transfer the primer to the patient's teeth.

The kit 10a also includes eight preweld assemblies 28a that are similar to the preweld assemblies 28 described above, and two packages of archwires 31a that are similar to the archwire packages 31 described above. Further, the kit 10a includes two ligatures dispensers 32a, a moisture control packet 44a and a Class II corrector package 50a that are similar to the ligature dispensers 32, the moisture control packet 44 and the Class II Corrector package 50 respectively.

In addition, the kit 10a includes a glass ionomer band cement that comprises a bottle 36a of liquid and a bottle 36a of powder. The liquid and powder in the bottles 36a are similar to the liquid and powder contained in the bottles 36 described above. Optionally, the powder and liquid in the bottles 36a are mixed together by the practitioner in one of the mixing wells 64a instead of a pad such as the pad 38.

Although not shown in the drawings, the kit 10a may also optionally include disposable, single use hand instruments such as a bracket holder 46 and the adhesive remover 48 mentioned above.

Other aspects of the kit 10a are preferably similar or identical to the aspects described in connection with the kit 10 set out above.

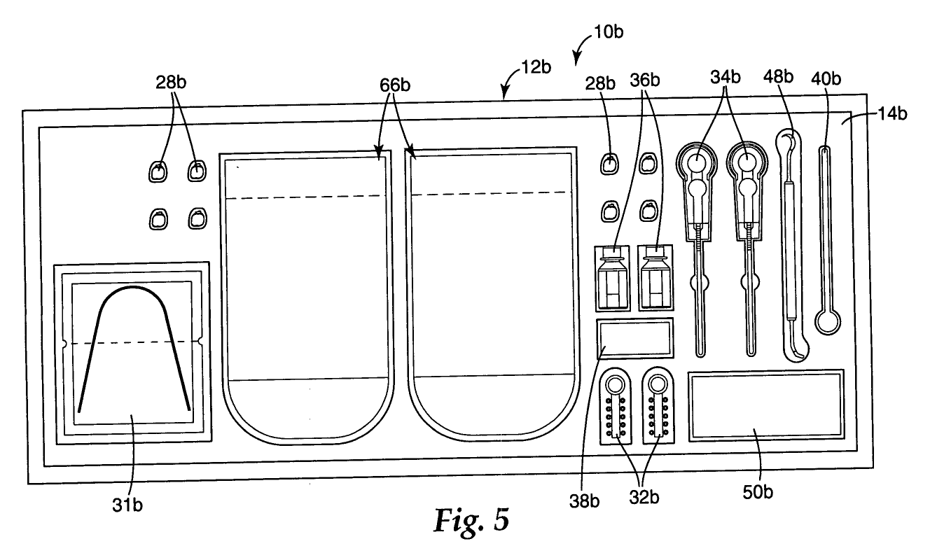

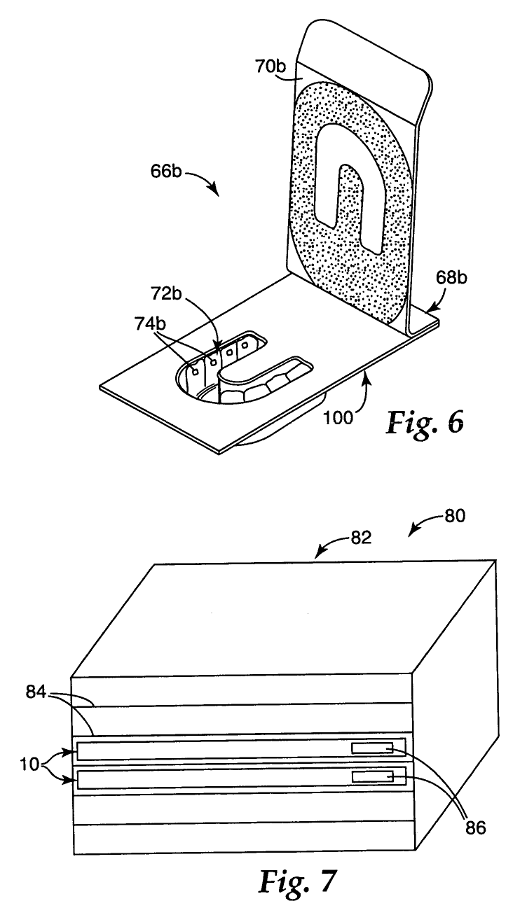

A single patient orthodontic kit 10b according to another embodiment of the invention is illustrated in FIG. 5. The kit 10b includes two packaged indirect bonding assemblies 66b, one of which is shown alone in FIG. 6.

In the example shown in FIG. 6, the indirect bonding assembly 66b includes an enclosure 68b having a generally “U”-shaped bottom and an upright sidewall that defines a generally “U”-shaped configuration in bottom view. A rectangular flange surrounds an opening to a chamber of the enclosure 68b and is integrally connected to the sidewall of the enclosure 68b. A pressure sensitive adhesive on a cover 70b of the enclosure 68b engages the top flange for releasably retaining the cover 70b in a closed position. In FIG. 6, the cover 70b is illustrated in an opened position in FIG. 6 and a closed position in FIG. 5.

An orthodontic placement device 72b is received in the chamber of the enclosure 68b. Preferably, the placement device 72b includes an outer shell and a matrix material that is received in the shell. The matrix material has a cavity with a configuration that matches at least a portion of the patient's dental arch.

A number of orthodontic brackets 74b are releasably connected to the placement device 72b. Optionally, other orthodontic appliances such as buccal tubes, buttons and other attachments may be used in place of the brackets 74b in certain instances as desired by the practitioner. Preferably, the base of each bracket 74b or other appliance has a configuration that precisely matches the configuration of a portion of a patient's tooth structure.

Preferably, a bonding composition extends across the base of each bracket. Preferably, the bonding composition is applied by the manufacturer to the base of each bracket before such time as the placement device 72b is placed in the enclosure 68b and the cover 70b is closed. Suitable bonding compositions include composites, compomers, glass ionomers and resin-modified glass ionomers. Examples of light-curable adhesives include Transbond XT brand and Transbond LR brand adhesives from 3M Unitek. Examples of chemical curing adhesives include Sondhi brand Rapid-Set indirect bonding adhesive, Unite brand adhesive, Concise brand adhesive and Multi-Cure brand glass ionomer cement from 3M Unitek.

Further details, options and alternative constructions for the indirect bond assembly 66b including the placement device 72b are described in Pending U.S. patent application Ser. No. 10/678,286, filed Oct. 3, 2003 and entitled “APPARATUS FOR INDIRECT BONDING OF ORTHODONTIC APPLIANCES AND METHOD OF MAKING THE SAME”, and Ser. No. 10/742,561, filed Dec. 19, 2003, and entitled “PACKAGED ORTHODONTIC ASSEMBLY WITH ADHESIVE PRECOATED APPLIANCES”.

Other aspects of the kit 10b are similar to the kits 10, 10a described above. In particular, the kit 10b includes eight preweld assemblies 28b, two archwire packages 31b, two ligature dispensers 32b, two packs of self-etching primer 34b, two bottles 36b containing components of a glass ionomer band cement, a mixing pad 38b, a Class II corrector package 50b, an adhesive remover 48b and a mixing spoon 40b, all of which are similar to the articles mentioned above.

FIG. 7 is a reduced perspective illustration of a system 80 that includes a plurality of single patient orthodontic kits such as kits 10. As shown, the kits 10 are slidably received in a storage tray 82 that includes a number of horizontally extending shelves 84. Each of the kits 10 is removed from the tray 82 as needed by the practitioner.

Preferably, the kits 10 include an external label 86 that is visible when the kits 10 are received in the tray 82. The label 86 bears identifying information, such as the patient's name, account number or other identifying information. Alternatively, or in addition to, the label 86 may bear information identifying the contents of the kit 10, including information such as the names and/or catalog numbers of the individual articles in the kit 10, the lot code(s), the date of manufacture, and information as may be required by statute or regulations.

Other constructions are also possible. For example, the kits 10 may be stackable, and optionally have sections that matingly fit or interlock with adjacent kits in the stack in order to help ensure that the kits 10 remain in a stacked vertical array. Optionally the containers 12 may include a layer of pressure sensitive adhesive extending along at least a portion of the bottom of the substrate 14, and the pressure sensitive adhesive is initially covered by a release liner. Upon removal of the release liner, the pressure sensitive adhesive may be utilized to temporarily affix the substrate 14 to a convenient location such as a countertop in the practitioner's operatory.

All of the patents, patent applications and published documents described herein are expressly incorporated by reference. Those skilled in the art may recognize that other options and additions to the kits described above are possible without departing from the spirit of our invention. Accordingly, the invention should not be deemed limited to the specific examples that are set out above in detail, but instead only by a fair scope of the claims that follow along with their equivalents.

1. A method of providing orthodontic articles to an orthodontic practitioner comprising:
selecting a set of brackets for a single patient;
selecting at least one archwire for the patient;
placing the set of brackets and the archwire in a container;
sterilizing the container while the brackets and the archwire are in the container; and
transporting the container with the brackets and the archwire to an orthodontic practitioner.

2. The method of claim 1 wherein the act of sterilizing the container is carried out using nuclear irradiation.

3. The method of claim 2 wherein the act of sterilizing the container using nuclear irradiation is carried out with gamma ray irradiation.

4. The method of claim 1 wherein the act of sterilizing the container is carried out using a gas or an electron beam.

5. The method of claim 1 and including the act of diagnosing the patient's malocclusion, and wherein the act of diagnosing the patient's malocclusion is carried out before the act of selecting a set of brackets.

6. The method of claim 1 wherein the act of sterilizing the container is carried out by the manufacturer.

7. The method of claim 1 and including the act of placing at least one of the following articles in the container with the set of brackets and the archwire: one or more hand instruments, one or more ligatures, one or more adhesives, one or more Class II correctors, one or more adhesive primers, one or more band cements, one or more preweld assemblies and one or more moisture control articles.

8. The method of claim 1 wherein the act of placing the set of brackets and the archwires in a container includes the act of placing the brackets in a set-up tray.

9. The method of claim 1 wherein the act of selecting a set of brackets is carried out at least in part by using digital data representative of the patient's teeth.

10. The method of claim 1 wherein the container includes a substrate and a cover that is connected to the substrate by a pressure sensitive adhesive.

11. The method of claim 1 wherein the container includes a substrate with at least one recess, and wherein at least one of the archwires and the brackets is received in one of the recesses.

12. The method of claim 1 wherein the act of transporting the container is carried out subsequent to the act of sterilizing the container.

13. The method of claim 1 wherein the act of selecting a set of brackets is carried out at least in part in the practitioner's office, and wherein the act of placing the set of brackets and the archwire in a container is carried out at a location remote from the practitioner's office.

14. The method of claim 1 wherein the act of selecting a set of brackets is carried out at least in part by software.

15. The method of claim 14 wherein the software operates on a computer that is remote from the practitioner's office.

16. An orthodontic kit that is made using the method of claim 1.

17. A method of providing orthodontic articles to an orthodontic practitioner comprising:
selecting a set of brackets for a single patient;
selecting at least one archwire for the patient;
placing the set of brackets and the archwire on a substrate;
transporting the substrate with the brackets and the archwire to an orthodontic practitioner; and
placing the substrate with the brackets and the archwire at a location adjacent an orthodontic patient's chair.

18. The method of claim 17 and including the act of diagnosing the patient's malocclusion, and wherein the act of diagnosing the patient's malocclusion is carried out before the act of selecting a set of brackets.

19. The method of claim 17 wherein the substrate is part of a container, and including the act of sterilizing the container while the brackets and the archwire are in the container.

20. The method of claim 17 and including the act of placing at least one of the following articles on a substrate with the set of brackets and the archwire: one or more hand instruments, one or more ligatures, one or more adhesives, one or more Class II correctors, one or more adhesive primers, one or more band cements, one or more preweld assemblies and one or more moisture control articles.

21. The method of claim 17 wherein the act of placing the set of brackets and the archwires on a substrate includes the act of placing the brackets in a set-up tray.

22. The method of claim 17 wherein the act of selecting a set of brackets is carried out at least in part by using digital data representative of the patient's teeth.

23. The method of claim 17 wherein the substrate includes at least one recess, and wherein at least one of the archwires and the brackets is received in one of the recesses.

24. The method of claim 17 wherein the act of selecting a set of brackets is carried out at least in part in the practitioner's office, and wherein the act of placing the set of brackets and the archwire on a substrate is carried out at a location remote from the practitioner's office.

25. The method of claim 17 wherein the act of selecting a set of brackets is carried out at least in part by software.

26. The method of claim 17 wherein the software operates on a computer that is remote from the practitioner's office.

27. An orthodontic kit that is made using the method of claim 17.
